(19) United States
(12) Patent Application Publication
(10) Pub. No.: US 2025/0180710 A1
(43) Pub. Date: Jun. 5, 2025

(54) SERIES MULTI-COIL CLAMSHELL DESIGN FOR ACTUATORS

(71) Applicant: Aeva, Inc., Mountain View, CA (US)

(72) Inventors: Adrit Lath, Mountain View, CA (US); Kurt Dageforde, Broomfield, CA (US); Neyram Hemati, Saratoga, CA (US)

(21) Appl. No.: 18/525,690

(22) Filed: Nov. 30, 2023

(51) Int. Cl. G01S 7/481; G01S 7/4911; G01S 7/4915; G01S 17/894

(52) U.S. Cl. CPC G01S 7/4817; G01S 7/4911; G01S 7/4915; G01S 17/894

(57) ABSTRACT

A system and method of using a series multi-coil clamshell design for actuators and/or limited angle actuators in an FMCW LIDAR system. The method includes providing an actuator coupled to an optical element. The actuator includes a rotor, a magnet, and a multi-coil structure including a first coil and a second coil. The magnet is attached to the rotor and each are enclosed within the multi-coil structure. The rotor includes a pair of recessed sections to permit a minimum distance between the magnet and the multi-coil structure and a minimum length of end turns of the first coil and the second coil to increase efficiency of the actuator. The method includes causing the rotor to rotate at a maximum angular acceleration associated with the minimum distance. The method includes transmitting an optical beam towards the optical element to cause the optical element to scatter the optical beam into free-space.

### TECHNICAL FIELD

The present disclosure relates generally to optical detection, and more particularly to systems and methods of using a series multi-coil clamshell design for actuators and/or limited angle actuators in a frequency modulated continuous wave (FMCW) light detection and ranging (LIDAR) system.

### BACKGROUND

An actuator is a component of a machine that is responsible for moving and controlling a mechanism or system. A rotary actuator is an actuator that produces a rotary motion or torque. They offer a smooth, accurate motion in conjunction with an elastic guiding for precise motion and pointing assemblies. LIDAR scanners use rotary actuators to scan a scene across a wide range of scanning angles. A limited angle actuator is a rotating actuator that can scan a scene across a limited range of scanning angles.

### SUMMARY

One aspect disclosed herein is directed to a method of using a series multi-coil clamshell design for actuators and/or limited angle actuators in an FMCW LIDAR system. The method includes providing an actuator coupled to an optical element. The actuator including a rotor, a magnet, and a multi-coil structure including a first coil and a second coil. The magnet is attached to the rotor and each are enclosed within the multi-coil structure. The rotor including a pair of recessed sections to permit, during rotations of the rotor, a minimum distance between the magnet and the multi-coil structure and a minimum length of end turns of the first coil and the second coil to increase efficiency of the actuator. The method causing, by a processing device, the rotor to rotate at a maximum angular acceleration that is associated with the minimum distance. The method includes transmitting an optical beam towards the optical element to cause the optical element to scatter the optical beam into free-space.

In another aspect, the present disclosure is directed to a system of using a series multi-coil clamshell design for actuators and/or limited angle actuators in an FMCW LIDAR system. The FMCW LIDAR system includes an actuator. The actuator is coupled to an optical element. The actuator includes a rotor, a magnet, and a multi-coil structure including a first coil and a second coil. The magnet is attached to the rotor and each are enclosed within the multi-coil structure. The rotor includes a pair of recessed sections to permit, during rotations of the rotor, a minimum distance between the magnet and the multi-coil structure and a minimum length of end turns of the first coil and the second coil to increase efficiency of the actuator. The processing device is configured to cause the rotor to rotate at a maximum angular acceleration that is associated with the minimum distance. The processing device is configured to transmit, using an optical source, an optical beam towards the optical element to cause the optical element to scatter the optical beam into free-space.

In another aspect, the present disclosure is directed to a system of using a series multi-coil clamshell design for actuators and/or limited angle actuators in an FMCW LIDAR system. The FMCW LIDAR system includes an optical source, an optical element, and an actuator. The actuator is coupled to the optical element. The actuator including a rotor, a magnet, and a multi-coil structure including a first coil and a second coil. The magnet is attached to the rotor and each are enclosed within the multi-coil structure. The rotor including a pair of recessed sections to permit, during rotations of the rotor, a minimum distance between the magnet and the multi-coil structure and a minimum length of end turns of the first coil and the second coil to increase efficiency of the actuator. The FMCW LIDAR system includes a processing device configured to cause the rotor to rotate at a maximum angular acceleration that is associated with the minimum distance. The processing device is further configured to cause the optical source to transmit an optical beam towards the optical element to cause the optical element to scatter the optical beam into free-space.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this summary is provided merely for purposes of summarizing some example implementations so as to provide a basic understanding of some aspects of the disclosure. Accordingly, it will be appreciated that the above-described example implementations are merely examples and should not be construed to narrow the scope or spirit of the disclosure in any way. Other example implementations, aspects, and advantages will become apparent from the following detailed description taken in conjunction with the accompanying figures which illustrate, by way of example, the principles of some described example implementations.

### BRIEF DESCRIPTION OF THE FIGURES

Embodiments and implementations of the present disclosure will be understood more fully from the detailed description given below and from the accompanying drawings of various aspects and implementations of the disclosure, which, however, should not be taken to limit the disclosure to the specific embodiments or implementations, but are for explanation and understanding only.

FIG. 1 is a block diagram illustrating an example of a LIDAR system, according to some embodiments;

FIG. 2 is a time-frequency diagram illustrating an example of an FMCW scanning signal that can be used by a LIDAR system to scan a target environment, according to some embodiments;

FIG. 3 is a block diagram illustrating an exploded view of an example actuator 300 that uses a series multi-coil clamshell design in an FMCW LIDAR system, according to some embodiments;

FIG. 4 is a block diagram illustrating an assembled view 400 of the actuator 300 in FIG. 3 as assembled with the housing, according to some embodiments;

FIG. 5 is a block diagram illustrating an assembled view 500 of the actuator 300 in FIG. 3 as assembled without the housing, according to some embodiments;

FIG. 6 is a block diagram illustrating a side view of the assembled actuator 300 in FIG. 6 to show end turns, according to some embodiments;

FIG. 7 is a block diagram illustrating a side view of the assembled actuator 300 in FIG. 6 to show minimized gaps, according to some embodiments;

FIG. 8A is a block diagram illustrating the side view of the assembled actuator 300 in FIG. 7, according to some embodiments;

FIG. 8B is a block diagram illustrating an alternate view of the assembled actuator 300 in FIG. 7, according to some embodiments;

FIG. 9 is a block diagram illustrating a top view of the assembled actuator 300 in FIG. 6 to show the magnetic fields flowing from the magnet, according to some embodiments; and

FIG. 10 is a flow diagram illustrating an example method for using a series multi-coil clamshell design for actuators in a FMCW LIDAR system, according to some embodiments.

### DETAILED DESCRIPTION

In a coherent LIDAR system, an FMCW transmitted light source (Tx) is used to determine the distance and velocity of objects in the scene by mixing a copy of the Tx source, known as the local oscillator (LO), with the received light (Rx) from the scene. The LO and Rx paths are combined on a fast photodiode (e.g., a photodetector), producing beat frequencies, proportional to object distance, which are processed electronically to reveal distance and velocity information of objects in the scene. To generate a point-cloud image, an actuator (e.g., a wide angle or limited angle actuator) rotates scanning optics (e.g., polygon mirrors) to deflect the Tx beam through the system field of view (FOV), which includes azimuth and/or zenith angles.

Conventional actuators such as a galvanometer (galvo) style actuator use a coil that surrounds a magnet. The magnet rotates while the coil remains stationary because the magnet is a part of the rotor. To maximize the torque per unit current, it is desirable to minimize the distance between the coil and the magnet as much as possible, but without allowing the coil and magnet from physically touching one another. The minimum distance allows more flux from the magnet to interact with the current flowing in the coil, which in turn, produces a torque on the rotor.

One of the limitations in being able to get the coil as close to the magnet is that the end turns of the coil need to be designed such that they do not interfere with the output shafts, but still allow for all the components to be assembled into the actuator. With a single coil, the end turns either need to be splayed apart or wound around a complex shape so the end turns do not intersect the shaft. Otherwise, accommodations need to be made in the magnet or shafts to permit the coil to pass through them.

However, due to the particular design of the conventional actuator, there are several clearance issues between the components of the actuator that make it impossible for the conventional actuator to achieve the optimal minimal distance between the coil and the magnet. Consequently, the conventional actuator is incapable of achieving a maximum torque per unit current to produce the optimal performance (e.g., scan rate, FOV, power consumptions, scan distance, etc.) for the LIDAR system. Thus, there is a long-felt but unsolved need to solve the problems of improving the performance and/or power consumption of an actuator without increasing the current input to the actuator and/or without increasing the physical dimensions of the actuator.

Accordingly, the present disclosure addresses the above-noted and other deficiencies by disclosing systems and methods of using a series multi-coil clamshell design for an actuator (e.g., limited angle actuators) in an FMCW LIDAR system. That is, the embodiments of the present disclosure use a series multi-coil clamshell design that splits (e.g., divides, separates) the coil of an actuator into two clamshells (e.g., portions, halves) that are wired (e.g., connected) in series. This approach allows for a much smaller clearance between the coil and magnet by allowing the coil to be assembled around the rotor instead of having the rotor pass through a hole in the coil. The two cylindrical sections of coil, formed such that when wired in series, function as a single monolithic coil that allow for assembly of the two halves to be closer to the magnet by having the end turns housed in recessed sections (e.g., cut-outs, grooves) in the rotor. The rotor is designed to provide sufficient clearance in the output shafts for the end-turns of the coils. The coil has coil support components (e.g., clamshell coil holder) that position the coil in the correct location with respect to the rotor and housing.

Specifically, the coils are wound as individual pieces with the end turns formed such that they bend away from the axis of rotation. The recessed sections in the rotor allow the end turns of the coil to have clearance since the rotor moves relative to the coil and physical contact between the parts is undesirable. The coils are located relative to the rotor by being constrained with the coil support components that are further constrained to the internal diameter of the housing. The rotor is constrained in a set of bearings which are constrained to the internal diameter of the housing. This ensures that the coil is located accurately to the rotor without making physical contact with the rotor.

Advantages of using the series multi-coil clamshell design include, for example, the ability for the actuator to achieve a higher torque per unit current for the same size of actuator, as compared to the conventional actuator that requires its rotor to pass through a monolithic coil. Therefore, for the same current input into the actuator, the resultant torque and acceleration of the payload is greater. The power consumption is also lower for the same desired acceleration.

Another advantage is that the recessed sections allow the actuator to use end turns with significantly reduced length, which reduces the electrical resistance of the end-turns, which in turn, maximizes the angular acceleration (and step-response time) of the actuator and without having to increase the current input to the actuator and/or having to increase the physical dimensions of the actuator.

In an illustrative embodiment, an FMCW LIDAR system includes an actuator, where the actuator is coupled to an optical element. The actuator includes a rotor, a magnet, and a multi-coil structure that includes a first coil and a second coil. The magnet is attached to the rotor, and both the rotor and magnet are enclosed within the multi-coil structure. The rotor includes a pair of recessed sections to permit, during rotations of the rotor, a minimum distance between the magnet and the multi-coil structure and a minimum length of end turns of the first coil and the second coil to increase efficiency of the actuator. A processing device of the FMCW LIDAR system is configured to cause the rotor to rotate at a maximum angular acceleration that is associated with the minimum distance. That is, the rotor is capable of rotating at the maximum angular acceleration because the magnet and the multi-coil structure are within the minimum distance and the end turns of the first coil and the second coil have been minimized. The processing device controls an optical source to cause the optical source to transmit an optical beam towards the optical element while the optical element is rotating, which causes the optical element to scatter the optical beam into free-space.

According to some embodiments, the described LIDAR system using a series multi-coil clamshell design for actuators may be implemented in a variety of sensing and detection applications, such as, but not limited to, automotive, communications, consumer electronics, and healthcare markets. According to some embodiments, the described LIDAR system using a series multi-coil clamshell design for actuators may be implemented as part of a front-end of an FMCW device that assists with spatial awareness for automated driver assist systems, or self-driving vehicles. According to some embodiments, the disclosed configuration may be agnostic to specific optical scanning architecture and can be tailored to enhance scanning LIDAR performance for a desired target range and/or to increase frame rate for a given range on the fly.

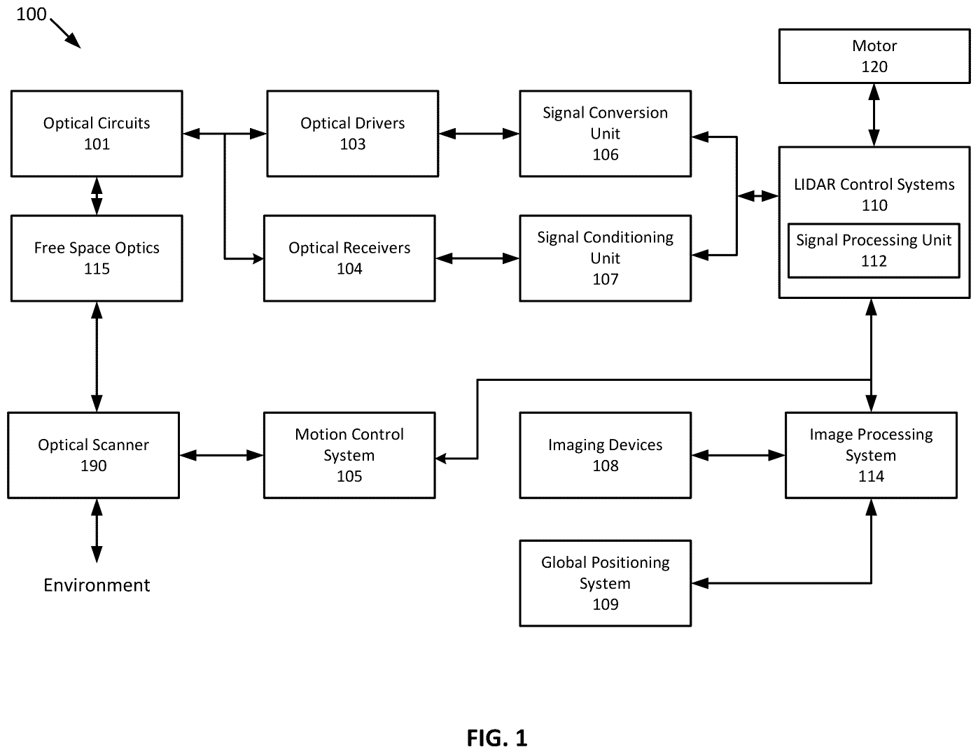

FIG. 1 is a block diagram illustrating an example of a LIDAR system, according to some embodiments. The LIDAR system 100 includes one or more of each of a number of components, but may include fewer or additional components than shown in FIG. 1. One or more of the components depicted in FIG. 1 can be implemented on a photonics chip, according to some embodiments. The optical circuits 101 may include a combination of active optical components and passive optical components. Active optical components may generate, amplify, and/or detect optical signals and the like. In some examples, the active optical component includes optical beams at different wavelengths, and includes one or more optical amplifiers, one or more optical detectors, or the like. In some embodiments, one or more LIDAR systems 100 may be mounted onto any area (e.g., front, back, side, top, bottom, and/or underneath) of a vehicle to facilitate the detection of an object in any free space relative to the vehicle. In some embodiments, the vehicle may include a steering system and a braking system, each of which may work in combination with one or more LIDAR systems 100 according to any information (e.g., distance/ranging information, Doppler information, etc.) acquired and/or available to the LIDAR system 100. In some embodiments, the vehicle may include a vehicle controller that includes the one or more components and/or processors of the LIDAR system 100.

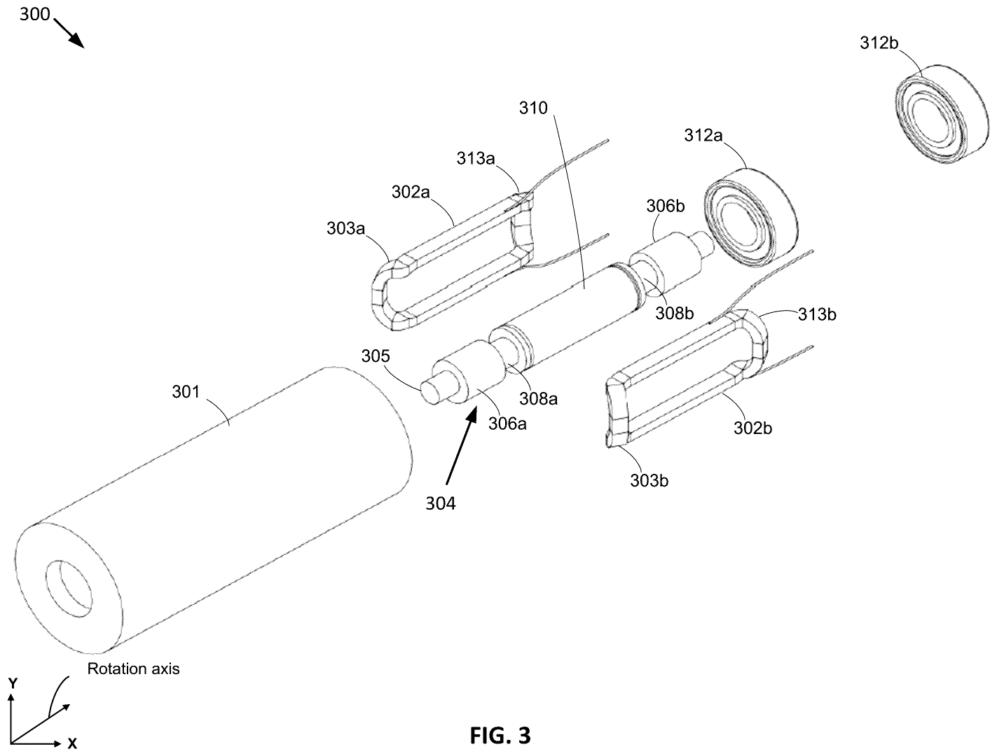

Free space optics 115 may include one or more optical waveguides to carry optical signals, and route and manipulate optical signals to appropriate input/output ports of the active optical circuit. In embodiments, the one or more optical waveguides may include one or more graded index waveguides, as will be described in additional detail below at FIGS. 3-6. The free space optics 115 may also include one or more optical components such as taps, wavelength division multiplexers (WDM), splitters/combiners, polarization beam splitters (PBS), collimators, couplers or the like. In some examples, the free space optics 115 may include components to transform the polarization state and direct received polarized light to optical detectors using a PBS, for example. The free space optics 115 may further include a diffractive element to deflect optical beams having different frequencies at different angles along an axis (e.g., a fast-axis).

In some examples, the LIDAR system 100 includes an optical scanner 190 that includes one or more scanning mirrors that are rotatable along an axis (e.g., a slow-axis) that is orthogonal or substantially orthogonal to the fast-axis of the diffractive element to steer optical signals to scan an environment according to a scanning pattern. For instance, the scanning mirrors may be rotatable by one or more galvanometers. Objects in the target environment may scatter an incident light into a return optical beam or a target return signal. The optical scanner 190 also collects the return optical beam or the target return signal, which may be returned to the passive optical circuit component of the optical circuits 101. For example, the return optical beam may be directed to an optical detector by a polarization beam splitter. In addition to the mirrors and galvanometers, the optical scanner 190 may include components such as a quarter-wave plate, lens, anti-reflective coated window or the like.

To control and support the optical circuits 101 and optical scanner 190, the LIDAR system 100 includes LIDAR control systems 110. The LIDAR control systems 110 may include a processing device for the LIDAR system 100. In some examples, the processing device may be one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. The processing device may also be one or more special-purpose processing devices such as an application specific integrated circuit (ASIC), a field programmable gate array (FPGA), a digital signal processor (DSP), network processor, or the like.

In some examples, the LIDAR control system 110 may include a processing device that may be implemented with a DSP, such as signal processing unit 112. The LIDAR control systems 110 are configured to output digital control signals to control optical drivers 103. In some examples, the digital control signals may be converted to analog signals through signal conversion unit 106. For example, the signal conversion unit 106 may include a digital-to-analog converter. The optical drivers 103 may then provide drive signals to active optical components of optical circuits 101 to drive optical sources such as lasers and amplifiers. In some examples, several optical drivers 103 and signal conversion units 106 may be provided to drive multiple optical sources.

The LIDAR control systems 110 are also configured to output digital control signals for the optical scanner 190. A motion control system 105 may control the galvanometers of the optical scanner 190 based on control signals received from the LIDAR control systems 110. For example, a digital-to-analog converter may convert coordinate routing information from the LIDAR control systems 110 to signals interpretable by the galvanometers in the optical scanner 190. In some examples, a motion control system 105 may also return information to the LIDAR control systems 110 about the position or operation of components of the optical scanner 190. For example, an analog-to-digital converter may in turn convert information about the galvanometers' position to a signal interpretable by the LIDAR control systems 110.

The LIDAR control systems 110 are further configured to analyze incoming digital signals. In this regard, the LIDAR system 100 includes optical receivers 104 to measure one or more beams received by optical circuits 101. For example, a reference beam receiver may measure the amplitude of a reference beam from the active optical component, and an analog-to-digital converter converts signals from the reference receiver to signals interpretable by the LIDAR control systems 110. Target receivers measure the optical signal that carries information about the range and velocity of a target in the form of a beat frequency, modulated optical signal. The reflected beam may be mixed with a second signal from a local oscillator. The optical receivers 104 may include a high-speed analog-to-digital converter to convert signals from the target receiver to signals interpretable by the LIDAR control systems 110. In some examples, the signals from the optical receivers 104 may be subject to signal conditioning by signal conditioning unit 107 prior to receipt by the LIDAR control systems 110. For example, the signals from the optical receivers 104 may be provided to an operational amplifier for amplification of the received signals and the amplified signals may be provided to the LIDAR control systems 110.

In some applications, the LIDAR system 100 may additionally include one or more imaging devices 108 configured to capture images of the environment, a global positioning system 109 configured to provide a geographic location of the system, or other sensor inputs. The LIDAR system 100 may also include an image processing system 114. The image processing system 114 can be configured to receive the images and geographic location, and send the images and location or information related thereto to the LIDAR control systems 110 or other systems connected to the LIDAR system 100.

In operation according to some examples, the LIDAR system 100 is configured to use nondegenerate optical sources to simultaneously measure range and velocity across two dimensions. This capability allows for real-time, long-range measurements of range, velocity, azimuth, and elevation of the surrounding environment.

In some examples, the scanning process begins with the optical drivers 103 and LIDAR control systems 110. The LIDAR control systems 110 instruct, e.g., via signal processing unit 112, the optical drivers 103 to independently modulate one or more optical beams, and these modulated signals propagate through the optical circuits 101 to the free space optics 115. The free space optics 115 directs the light at the optical scanner 190 that scans a target environment over a preprogrammed pattern defined by the motion control system 105. The optical circuits 101 may also include a polarization wave plate (PWP) to transform the polarization of the light as it leaves the optical circuits 101. In some examples, the polarization wave plate may be a quarter-wave plate or a half-wave plate. A portion of the polarized light may also be reflected back to the optical circuits 101. For example, lensing or collimating systems used in LIDAR system 100 may have natural reflective properties or a reflective coating to reflect a portion of the light back to the optical circuits 101.

Optical signals reflected back from an environment pass through the optical circuits 101 to the optical receivers 104. Because the polarization of the light has been transformed, it may be reflected by a polarization beam splitter along with the portion of polarized light that was reflected back to the optical circuits 101. In such scenarios, rather than returning to the same fiber or waveguide serving as an optical source, the reflected signals can be reflected to separate optical receivers 104. These signals interfere with one another and generate a combined signal. The combined signal can then be reflected to the optical receivers 104. Also, each beam signal that returns from the target environment may produce a time-shifted waveform. The temporal phase difference between the two waveforms generates a beat frequency measured on the optical receivers 104 (e.g., photodetectors).

The analog signals from the optical receivers 104 are converted to digital signals by the signal conditioning unit 107. These digital signals are then sent to the LIDAR control systems 110. A signal processing unit 112 may then receive the digital signals to further process and interpret them. In some embodiments, the signal processing unit 112 also receives position data from the motion control system 105 and galvanometers (not shown) as well as image data from the image processing system 114. The signal processing unit 112 can then generate 3D point cloud data (sometimes referred to as, “a LIDAR point cloud”) that includes information about range and/or velocity points in the target environment as the optical scanner 190 scans additional points. In some embodiments, a LIDAR point cloud may correspond to any other type of ranging sensor that is capable of Doppler measurements, such as Radio Detection and Ranging (RADAR). The signal processing unit 112 can also overlay 3D point cloud data with image data to determine velocity and/or distance of objects in the surrounding area. The signal processing unit 112 also processes the satellite-based navigation location data to provide data related to a specific global location.

The LIDAR system 100 includes a motor 120 that is communicatively coupled to the LIDAR control system 110 via a communication interface.

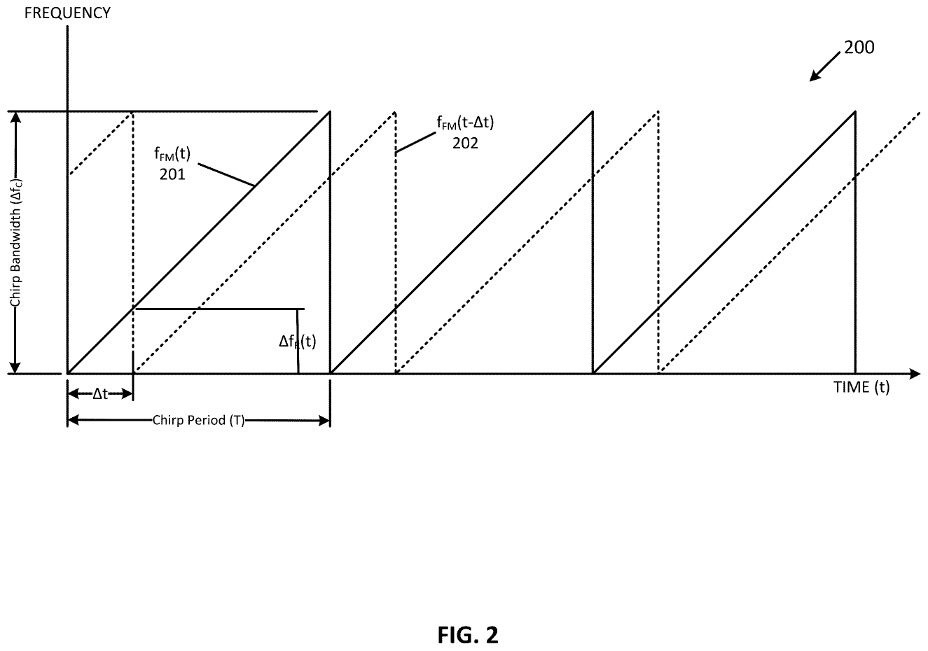

FIG. 2 is a time-frequency diagram illustrating an example of an FMCW scanning signal that can be used by a LIDAR system to scan a target environment, according to some embodiments. In one example, the scanning waveform 201, labeled as f_{FM}(t), is a sawtooth waveform (sawtooth “chirp”) with a chirp bandwidth Δf_{C} and a chirp period T_{C}. The slope of the sawtooth is given as k=(Δf_{C}/T_{C}). FIG. 2 also depicts target return signal 202 according to some embodiments. Target return signal 202, labeled as f_{FM}(t−Δt), is a time-delayed version of the scanning waveform 201, where Δt is the round trip time to and from a target illuminated by scanning waveform 201. The round trip time is given as Δt=2R/ν, where R is the target range and ν is the velocity of the optical beam, which is the speed of light c. The target range, R, can therefore be calculated as R=c(Δt/2). When the return signal 202 is optically mixed with the scanning signal, a range-dependent difference frequency (“beat frequency”) Δf_{R}(t) is generated. The beat frequency Δf_{R}(t) is linearly related to the time delay Δt by the slope of the sawtooth k. That is, Δf_{R}(t)=kΔt. Since the target range R is proportional to Δt, the target range R can be calculated as R=(c/2)(Δf_{R}(t)/k). That is, the range R is linearly related to the beat frequency Δf_{R}(t). The beat frequency Δf_{R}(t) can be generated, for example, as an analog signal in optical receivers 104 of LIDAR system 100. The beat frequency can then be digitized by an analog-to-digital converter (ADC), for example, in a signal conditioning unit such as signal conditioning unit 107 in LIDAR system 100. The digitized beat frequency signal can then be digitally processed, for example, in a signal processing unit, such as signal processing unit 112 in LIDAR system 100. It should be noted that the target return signal 202 will, in general, also includes a frequency offset (Doppler shift) if the target has a velocity relative to the LIDAR system 100. The Doppler shift can be determined separately, and used to correct (e.g., adjust, modify) the frequency of the return signal, so the Doppler shift is not shown in FIG. 2 for simplicity and ease of explanation. For example, LIDAR system 100 may correct the frequency of the return signal by removing (e.g., subtracting, filtering) the Doppler shift from the frequency of the returned signal to generate a corrected return signal. The LIDAR system 100 may then use the corrected return signal to calculate a distance and/or range between the LIDAR system 100 and the object. In some embodiments, the Doppler frequency shift of target return signal 202 that is associated with an object may be indicative of a velocity and/or movement direction of the object relative to the LIDAR system 100.

It should also be noted that the sampling frequency of the ADC will determine the highest beat frequency that can be processed by the system without aliasing. In general, the highest frequency that can be processed is one-half of the sampling frequency (i.e., the “Nyquist limit”). In one example, and without limitation, if the sampling frequency of the ADC is 1 gigahertz, then the highest beat frequency that can be processed without aliasing (Δf_{Rmax}) is 500 megahertz. This limit in turn determines the maximum range of the system as Rₘₐₓ=(c/2)(Δf_{Rmax}/k) which can be adjusted by changing the chirp slope k. In one example, while the data samples from the ADC may be continuous, the subsequent digital processing described below may be partitioned into “time segments” that can be associated with some periodicity in the LIDAR system 100. In one example, and without limitation, a time segment might correspond to a predetermined number of chirp periods T, or a number of full rotations in azimuth by the optical scanner.

FIG. 3 is a block diagram illustrating an exploded view of an example actuator that uses a series multi-coil clamshell design in an FMCW LIDAR system, according to some embodiments. The actuator 300 includes a housing 301 that may be made from any material including, for example, plastic, metal (e.g., aluminum), and/or ceramic. The actuator 300 includes a rotor assembly 304 that includes a rotor 305 and a magnet 310. The actuator 300 includes bearings 312 (e.g., bearing 312a and bearing 312b).

The rotor 305 is shaped as a cylinder having a first circular base, a second circular base, and sides. The first circular base and second circular base of the rotor 305 each have a rotor diameter. The magnet 310 is also shaped as a cylinder having a first circular base, a second circular base, and sides. The first circular base and second circular base of the magnet 310 each have the same magnet diameter. The magnet 310 includes a hole that passes through its first circular base and its second circular base. The rotor diameter is smaller than the magnet diameter to allow the rotor assembly 304 to be inserted into the hole of the magnet 310. Alternatively, instead of pushing the rotor assembly 304 through the hole of the magnet 310, the magnet 310 can be wrapped around the midpoint of the rotor 305 during the manufacturing of the magnet 310. In some embodiments, the magnet 310 does not include a hole that passes through the first circular base and the second circular base of the magnet 310, but instead, an output shaft 306a of the rotor 305 and a rear shaft 306b of the rotor 305 are each glued to the faces of the magnet.

The magnet 310 is attached (e.g., bonded, fused) to the rotor 305 to form the rotor assembly 304 and the rotor assembly 304 is configured to rotate about an axis of rotation. If the magnet 310 is exposed to a magnetic field, then the magnet 310 may be attracted to or repelled by the magnetic field, which in turn, causes the magnet 310 and the rotor 305 (because they are attached to one another) to rotate together about the axis of rotation. The rotor assembly 304 can rotate in the clock-wise position or counter clock-wise position for any number of partial or complete rotations.

As shown in FIG. 3, a first portion of the rotor 305 is referred to as the output shaft 306a and a second portion of the rotor 305 is referred to as the rear shaft 306b. The output shaft 306a protrudes along the angle of rotation away from one end of the magnet 310 and the rear shaft 306b protrudes along the angle of rotation away from the end of the magnet 310. The magnet 310 is between the output shaft 306a and the rear shaft 306b.

The actuator 300 includes a coil 302a and a coil 302b. The coil 302a includes end turns 303a and end turns 313a that each bend away from the axis of rotation. The coil 302b includes end turns 303b and end turns 313b that each bend away from the axis of rotation.

During the manufacturing process, the coil 302a and the coil 302b are assembled around the rotor assembly 304 and the magnet 310 to create a multi-coil structure. Specifically, a human or machine presses the coil 302a and the coil 302b together and holds them in place by using bonding or other mechanical attachment methods like clamps (e.g., glue, epoxy). The human or machine constrains the output shaft 306a by inserting the output shaft 306a into the hole of the bearing 312a. The human or machine constrains the rear shaft 306b by inserting the rear shaft 306b into the hole of the bearing 312b. The human or machine inserts the multi-coil structure and the bearings 312a, 312b into the housing 301. The human or machine electrically connects the coil 302a and the coil 302b in series. In some embodiments, the bearings 312a, 312b and the housing 301 sufficiently hold the coils 302a, 302b together such that no bonding is needed between the coils 302a, 302b. The human or machine then bonds the coil 302a and/or coil 302b to the housing 301 to keep them static.

The rotor assembly 304 includes a recessed section 308a that is positioned between the output shaft 306a and the magnet 310. The recessed section 308a has a diameter that is less than the diameter of the output shaft 306a. The rotor assembly 304 includes a recessed section 308b that is positioned between the rear shaft 306b and the magnet 310. The recessed section 308b has a diameter that is less than the diameter of the rear shaft 306b.

The recessed section 308a and the recessed section 308b provide several benefits for the actuator 300. For one, the recessed section 308a and the recessed section 308b allow the actuator 300 to achieve a smallest possible distance between the magnet 310 and the multi-coil structure; thereby maximizing the efficiency of the actuator. For example, the human or machine inserts end turns 303a of coil 302a and end turns 303b of coil 302b into recessed section 308a, which creates a larger clearance between the multi-coil structure and the magnet 310, which in turn, allows the human and machine to further reduce the distance between the multi-coil structure and the magnet 310.

Another benefit is that the recessed section 308a and the recessed section 308b allow the actuator 300 to use end turns 303a, 303b with significantly reduced length, which reduces the electrical resistance of the end-turns 303a, 303b, which in turn, maximizes the angular acceleration (and step-response time) of the actuator 300 and without having to increase the current input to the actuator and/or having to increase the physical dimensions of the actuator.

As discussed above, the end turns 303a of coil 302a and the end turns 303b of coil 302b are each positioned in the recessed section 308a and end turns 313a of coil 302a and the end turns 313b of coil 302b are each positioned in the recessed section 308b. Because the end turns 303a, 303b bend away from the axis of rotation, there is a first maximum distance between the end turns 303a, 303b as they sit in the recessed section 308a and a second maximum distance between the end turns 313a, 313b as they sit in the recessed section 308b. The design of the actuator 300 allows for a maximum angular acceleration of the rotor assembly 304 without having to increase an input current to the actuator 300 by using the recessed sections 308a, 308b to maintain the first maximum distance and second maximum distance to each be less than a diameter of the magnet 310 and/or to reduce a loss (e.g., loss in efficiency, etc.) associated with the end turns. Advantageously, this design results in less resistance as the rotor assembly 304 rotates about the rotation axis, which allows the rotor assembly 304 to achieve a maximized angular acceleration and with less heat generation as compared to conventional actuators.

The multi-coil structure has a hole that passes through the multi-coil structure. The first opening of the hole is formed by end turns 303a of coil 302a and end turns 303b of coil 302b. The second opening of the hole is formed by end turns 313a of coil 302a and end turns 313b of coil 302b.

As shown in FIG. 3, a portion of the rotor assembly 304 that is near the output shaft 306a protrudes out from the openings of the hole in the multi-coil structure. A different portion of the rotor assembly 304 that is near the rear shaft 306b protrudes out from the openings of the hole in the multi-coil structure.

A processing device can cause the rotor assembly 304 to rotate about the rotation axis and at a maximum angular acceleration. For example, the processing device can cause an input current to be provided to the coil 302a, which passes through the coil 302a and then through the coil 302b because the coils 302a, 302b are connected in series. The passing of the input current through the coils 302a, 302b causes a magnetic field to be generated, which imposes a force on the magnet to rotate the rotor assembly 304.

In some embodiments, the processing device may limit the rotation of the rotor assembly 304 to within a predetermined range of rotation angles, such to prevent the rotor assembly 304 from continuously rotating 360 degrees about the axis. In other words, the processing device may move the rotor assembly 304 to a first angle, pause, and then move the rotor assembly 304 to a second angle.

As discussed above, the angular acceleration of the rotor assembly 304 is inversely proportional to the distance between the magnet 310 and the multi-coil structure. For example, the design of the actuator 300 allows an actuator designer to reduce the distance between the magnet 310 and the multi-coil structure, as well as reduce the length and electrical resistance of the end turns 303a, 303b, each which cause the angular acceleration to proportionally increase and without increasing the current input to the actuator and/or without increasing the physical dimensions of the actuator.

By assembling (e.g., wrapping) the multi-coil structure around the rotor assembly 304 and the magnet 310 and doing so without inserting the rotor assembly 304 through an opening of the hole that passes through the multi-coil structure, it is possible to achieve a much smaller minimum distance between the coils (e.g., coil 302a and coil 302b) and the magnet 310, as compared to the minimum distance that is capable with conventional actuators that use a single-coil structure. One of the reasons for this is that the conventional actuator must be assembled by inserting the magnet and rotor assembly through the hole that passes through the single-coil structure because the single-coil structure cannot be split or opened. This forces the actuator designer to design the actuator with large dimensions, so to ensure that the magnet and rotor assembly to pass through the hole of the single-coil structure, which in turn, restricts the ability for the actuator designer to achieve an optimal minimum distance between the single-coil structure and the magnet.

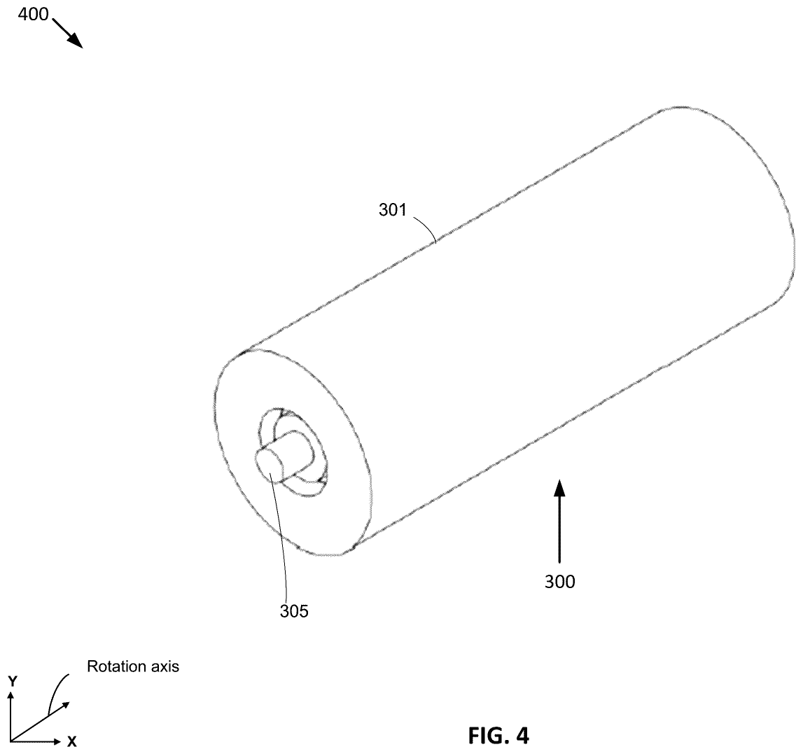

FIG. 4 is a block diagram illustrating an assembled view 400 of the actuator 300 in FIG. 3 as assembled with the housing, according to some embodiments. As shown in the assembled view 400, the components (e.g., coil 302, coil 302b, bearings 312, and the rotor assembly 304) are assembled together and inserted into the housing 301. The rotor assembly 304 can rotate unobstructed by the housing 301 when inserted in the housing 301.

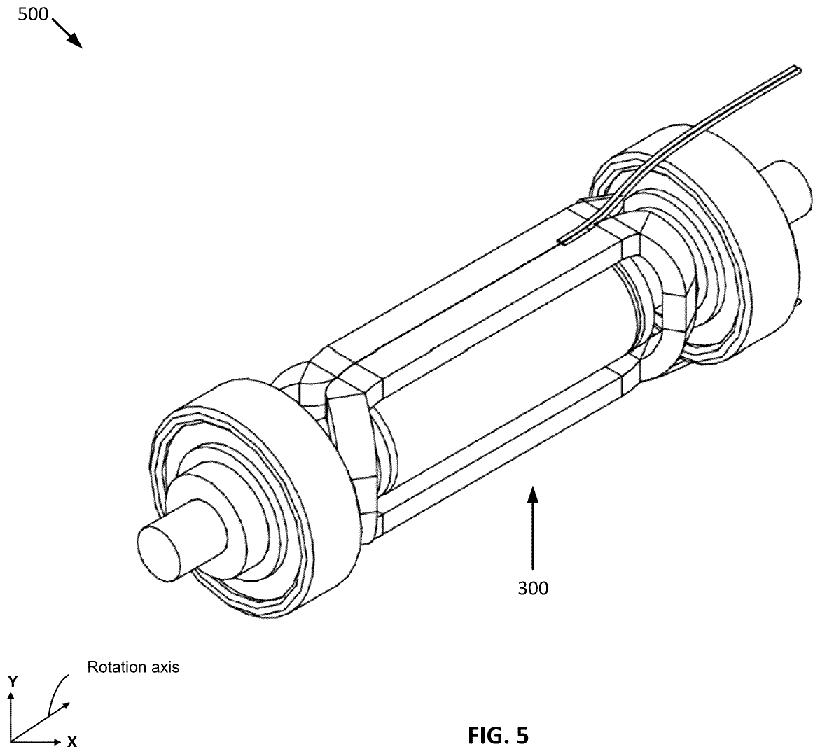

FIG. 5 is a block diagram illustrating an assembled view 500 of the actuator 300 in FIG. 3 as assembled without the housing, according to some embodiments. As shown in the assembled view 500, the components (e.g., coils 302, bearings 312, and the rotor assembly 304) are assembled together, but not inserted into the housing 301. The magnet 310 is bonded to the rotor 305 (sometimes the magnet 310 and the rotor 305 are collectively referred to as the rotor 305) and they are configured to rotate together (e.g., as one). At the time that the components are assembled together and inserted into the housing 301, the coils 302a, 302b are bonded to the housing 301 and remain static.

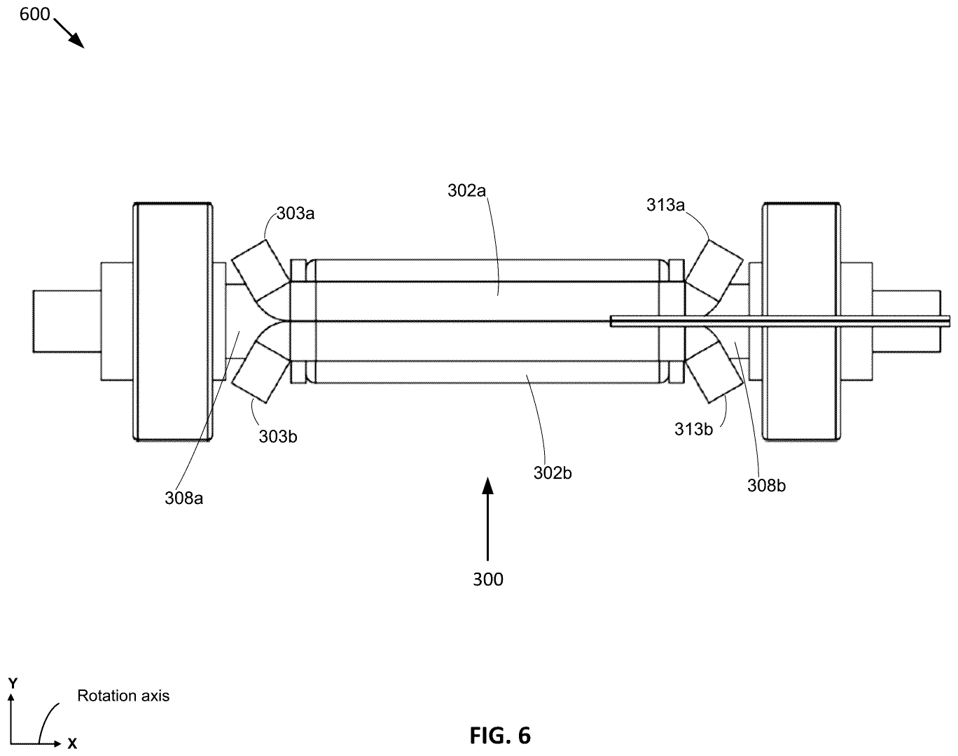

FIG. 6 is a block diagram illustrating a side view of the assembled actuator 300 in FIG. 6 to show end turns, according to some embodiments. The side view shows that the end turns 303a and 313a of coil 302a go around the recessed sections 308a, 308b. The side view also shows that the end turns 303b and 313b of coil 302b also go around the recessed sections 308a, 308b.

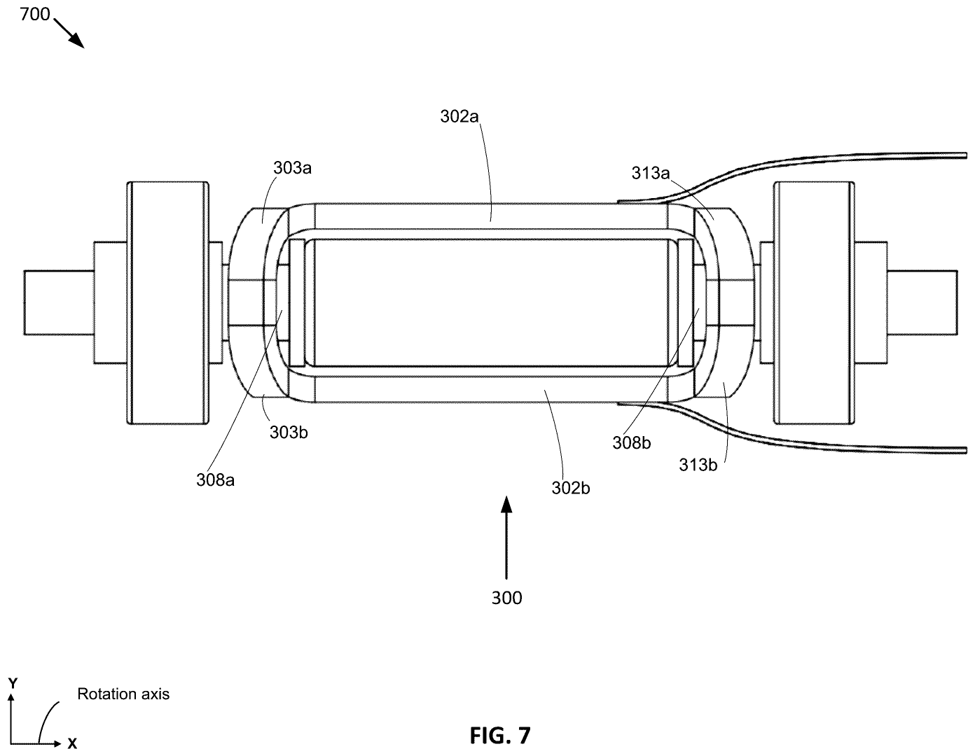

FIG. 7 is a block diagram illustrating a side view of the assembled actuator 300 in FIG. 6 to show minimized gaps, according to some embodiments. The side view shows a distance (e.g., gap, space) between the magnet 310 and the coils 302a, 302b to prevent the magnet 310 from physically touching the coils 302a, 302b. Minimizing this distance causing the actuator 300 to operate more efficiently (e.g., more torque per unit current) and at a higher angular acceleration.

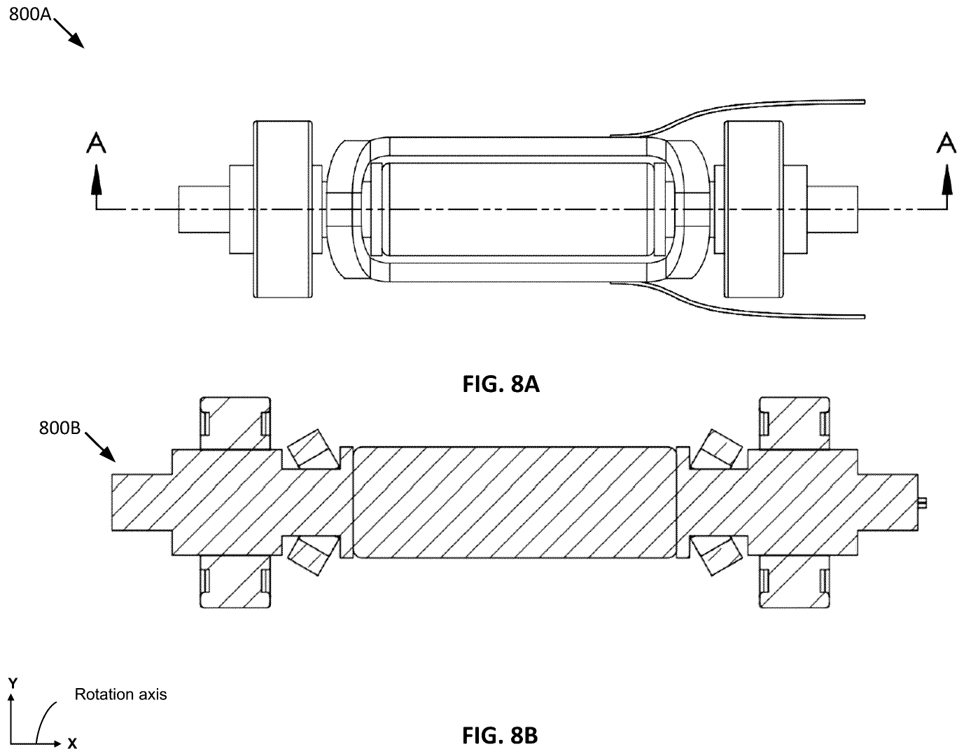

FIG. 8A is a block diagram illustrating the side view of the assembled actuator 300 in FIG. 7, according to some embodiments. The recessed sections (sometimes referred to as recessed regions) for the end turns 308 allow the coils 302 to be closer to the magnet 310.

FIG. 8B is a block diagram illustrating an alternate view of the assembled actuator 300 in FIG. 7, according to some embodiments. The end turns 308 allow the coils 302 to be assembled from either side around the rotor 305.

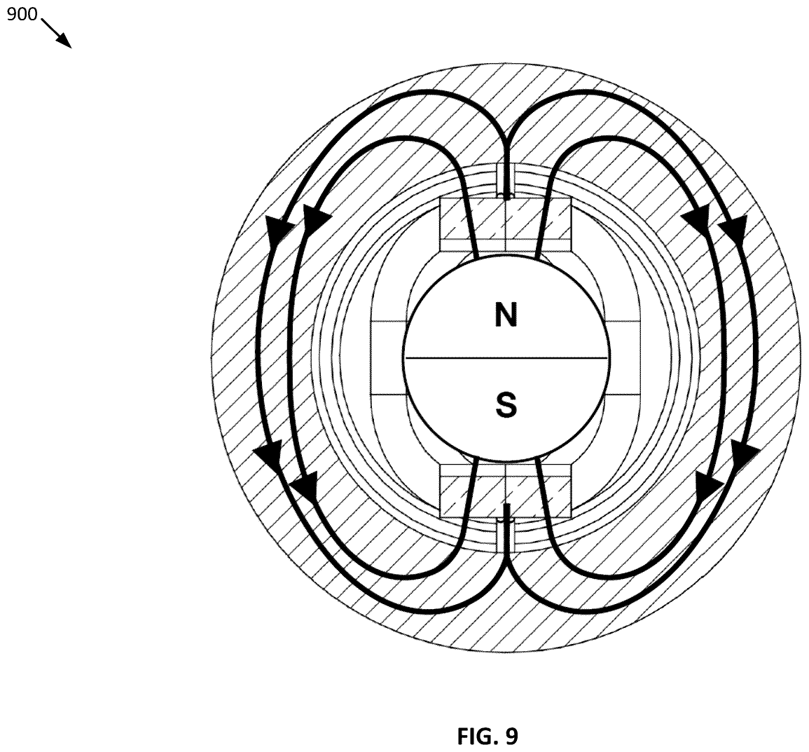

FIG. 9 is a block diagram illustrating a top view of the assembled actuator 300 in FIG. 6 to show the magnetic fields flowing from the magnet, according to some embodiments. A processing device can cause the rotor assembly 304 to rotate about the rotation axis and at a maximum angular acceleration that is associated with a minimum distance between the magnet 310 and the multi-coil structure. For example, the processing device can cause an input current to be provided to the coil 302a, which passes through the coil 302a and then through the coil 302b because the coils 302a, 302b are connected in series. The passing of the input current through the coils 302a, 302b causes a magnetic field to be generated, which imposes a force on the magnet to rotate the rotor assembly 304. As shown in FIG. 9, magnetic field lines flow from the north pole of the magnet intersecting the coils 302a, 302b, through the body and back of the south pole through the coil 302b on the opposite side.

In some embodiments, the actuator 300 may be added as a component of the LIDAR system 100 in FIG. 1 or be used to replace or modify any of the one or more components (e.g., free space optics 115, optical circuits, optical receivers 104, optical scanner 190, motion control system 105, etc.) of the LIDAR system 100.

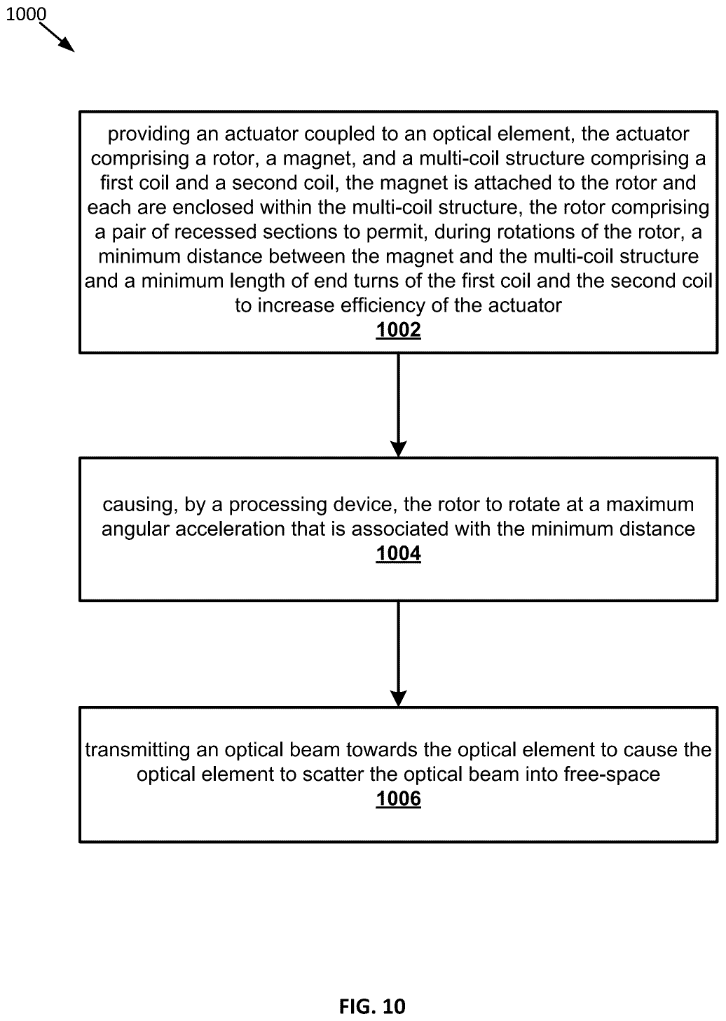

FIG. 10 is a flow diagram illustrating an example method for using a series multi-coil clamshell design for actuators in a FMCW LIDAR system, according to some embodiments. Additional, fewer, or different operations may be performed in the method depending on the particular arrangement. In some embodiments, some or all operations of method 1000 may be performed by one or more processors executing on one or more computing devices, systems, or servers (e.g., remote/networked servers or local servers). In some embodiments, one or more operations of method 1000 may be performed by a signal processing unit, such as signal processing unit 112 in FIG. 1. In some embodiments, one or more operations of method 1000 may be performed by any of the actuator 300 in FIG. 3. In some embodiments, one or more operations of method 1000 may be performed by the signal processing unit 112 and one or more operations of method 1000 may be performed by the actuator 300. Each operation may be re-ordered, added, removed, or repeated.

In some embodiments, the method 1000 may include the operation 1002 of providing an actuator coupled to an optical element, the actuator comprising a rotor, a magnet, and a multi-coil structure comprising a first coil and a second coil, the magnet is attached to the rotor and each are enclosed within the multi-coil structure, the rotor comprising a pair of recessed sections to permit, during rotations of the rotor, a minimum distance between the magnet and the multi-coil structure and a minimum length of end turns of the first coil and the second coil to increase efficiency of the actuator. In some embodiments, the method 1000 may include the operation 1004 of causing, by a processing device, the rotor to rotate at a maximum angular acceleration that is associated with the minimum distance. In some embodiments, the method 100 may include the operation 1006 of transmitting an optical beam towards the optical element to cause the optical element to scatter the optical beam into free-space.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. While this specification contains many specific implementation details, these should not be construed as limitations on the scope of any embodiments or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination. Moreover, the separation of various system components in the embodiments described above should not be understood as requiring such separation in all embodiments, and it should be understood that the described program components and systems can generally be integrated together in a single software product or packaged into multiple software products. Particular embodiments may vary from these exemplary details and still be contemplated to be within the scope of the present disclosure.

Reference throughout this specification to “one embodiment” or “an embodiment” means that a particular feature, structure, or characteristic described in connection with the embodiments included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

Although the operations of the methods herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be in an intermittent or alternating manner.

The above description of illustrated implementations of the present embodiments, including what is described in the Abstract, is not intended to be exhaustive or to limit the present embodiments to the precise forms disclosed. While specific implementations of, and examples for, the present embodiments are described herein for illustrative purposes, various equivalent modifications are possible within the scope of the present embodiments, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

What is claimed is:

1. A method comprising:
providing an actuator coupled to an optical element, the actuator comprising a rotor, a magnet, and a multi-coil structure comprising a first coil and a second coil, the magnet is attached to the rotor and each are enclosed within the multi-coil structure, the rotor comprising a pair of recessed sections to permit, during rotations of the rotor, a minimum distance between the magnet and the multi-coil structure and a minimum length of end turns of the first coil and the second coil to increase efficiency of the actuator;
causing, by a processing device, the rotor to rotate at a maximum angular acceleration that is associated with the minimum distance; and
transmitting an optical beam towards the optical element to cause the optical element to scatter the optical beam into free-space.

2. The method of claim 1, wherein causing, by the processing device, the rotor to rotate at the maximum angular acceleration that is associated with the minimum distance, further comprises:
limiting a rotation of the rotor to within a predetermined range of rotation angles.

3. The method of claim 1, wherein the multi-coil structure comprises a hole passing through the multi-coil structure, and further comprising:
enclosing the rotor and the magnet within the multi-coil structure by assembling the multi-coil structure around the rotor and the magnet and without inserting the rotor through an opening of the hole passing through the multi-coil structure.

4. The method of claim 1, wherein the rotor rotates about an axis of rotation, and further comprising:
inserting a first group of end turns of the first coil and the second coil into a first recessed section of the pair of recessed sections to provide, during the rotations of the rotor, a first clearance between the rotor and the first coil and the second coil; and
inserting a second group of end turns of the first coil and the second coil into a second recessed section of the pair of recessed sections to provide, during the rotations of the rotor, a second clearance between the rotor and the first coil and the second coil.

5. The method of claim 4, wherein a sub-group of end turns of the first group of end turns in the first recessed section that are associated with the first coil and a sub-group of end turns of the first group of end turns in the first recessed section that are associated with the second coil are separated by a first distance, and wherein a sub-group of end turns of the second group of end turns in the second recessed section that are associated with the first coil and a sub-group of end turns of the second group of end turns in the second recessed section that are associated with the second coil are separated by a second distance, and further comprising:
maintaining the first distance and the second distance to reduce a loss associated with the end turns of the first coil and the second coil.

6. The method of claim 4, further comprising:
using the first recessed section and the second recessed section to achieve the minimum distance between the magnet and the multi-coil structure during the rotations of the rotor to maximize efficiency of the actuator.

7. The method of claim 6, wherein the actuator further comprises a first bearing having a first hole and a second bearing having a second hole, and further comprising:
constraining an output shaft of the rotor within the first bearing via the first hole; and
constraining a rear shaft of the rotor within the second bearing via the second hole.

8. The method of claim 7, wherein:
the first recessed section of the pair of recessed sections is between the output shaft of the rotor and the magnet, and
the second recessed section of the pair of recessed sections is between the rear shaft of the rotor and the magnet.

9. The method of claim 1, further comprising:
electrically connecting the first coil and the second coil in series.

10. The method of claim 1, further comprising:
passing a first input current through the first coil and the second coil.

11. A frequency modulated continuous wave (FMCW) light detection and ranging (LIDAR) system, the system comprising:
an actuator, the actuator is coupled to an optical element, the actuator comprising a rotor, a magnet, and a multi-coil structure comprising a first coil and a second coil, the magnet is attached to the rotor and each are enclosed within the multi-coil structure, the rotor comprising a pair of recessed sections to permit, during rotations of the rotor, a minimum distance between the magnet and the multi-coil structure and a minimum length of end turns of the first coil and the second coil to increase efficiency of the actuator; and
a processing device configured to:
cause the rotor to rotate at a maximum angular acceleration that is associated with the minimum distance; and
transmit, using an optical source, an optical beam towards the optical element to cause the optical element to scatter the optical beam into free-space.

12. The FMCW LIDAR system of claim 11, wherein to cause the rotor to rotate at the maximum angular acceleration that is associated with the minimum distance, the processing device is further to:
limit a rotation of the rotor to within a predetermined range of rotation angles.

13. The FMCW LIDAR system of claim 11, wherein:
the multi-coil structure comprises a hole passing through the multi-coil structure, and
the multi-coil structure is assembled around the rotor and the magnet and without inserting the rotor through an opening of the hole passing through the multi-coil structure.

14. The FMCW LIDAR system of claim 11, wherein the processing device is further to rotate the rotor about an axis of rotation, and wherein:
a first group of end turns of the first coil and the second coil are inserted into a first recessed section of the pair of recessed sections to provide, during the rotations of the rotor, a first clearance between the rotor and the first coil and the second coil; and
a second group of end turns of the first coil and the second coil are inserted into a second recessed section of the pair of recessed sections to provide, during the rotations of the rotor, a second clearance between the rotor and the first coil and the second coil.

15. The FMCW LIDAR system of claim 14, wherein:
a sub-group of end turns of the first group of end turns in the first recessed section that are associated with the first coil and a sub-group of end turns of the first group of end turns in the first recessed section that are associated with the second coil are separated by a first distance,
a sub-group of end turns of the second group of end turns in the second recessed section that are associated with the first coil and a sub-group of end turns of the second group of end turns in the second recessed section that are associated with the second coil are separated by a second distance, and
the first distance and the second distance are each less than a diameter of the magnet to reduce a loss associated with the end turns of the first coil and the second coil.

16. The FMCW LIDAR system of claim 14, wherein the first recessed section and the second recessed section are used to achieve the minimum distance between the magnet and the multi-coil structure during the rotations of the rotor to maximize efficiency of the actuator.

17. The FMCW LIDAR system of claim 16, wherein:
the actuator further comprises a first bearing having a first hole and a second bearing having a second hole;
the rotor further comprises an output shaft that is constrained within the first bearing via the first hole; and
the rotor further comprises a rear shaft that is constrained within the second bearing via the second hole.

18. The FMCW LIDAR system of claim 17, wherein:
the first recessed section of the pair of recessed sections is between the output shaft of the rotor and the magnet, and
the second recessed section of the pair of recessed sections is between the rear shaft of the rotor and the magnet.

19. The FMCW LIDAR system claim 11, wherein the first coil and the second coil are electrically connected in series, and wherein to cause the rotor to rotate at the maximum angular acceleration that is associated with the minimum distance, the processing device is further configured to:
pass a first input current through the first coil and the second coil.

20. A frequency modulated continuous wave (FMCW) light detection and ranging (LIDAR) system, the system comprising:
an optical source;
an optical element;
an actuator, the actuator is coupled to the optical element, the actuator comprising a rotor, a magnet, and a multi-coil structure comprising a first coil and a second coil, the magnet is attached to the rotor and each are enclosed within the multi-coil structure, the rotor comprising a pair of recessed sections to permit, during rotations of the rotor, a minimum distance between the magnet and the multi-coil structure and a minimum length of end turns of the first coil and the second coil to increase efficiency of the actuator; and
a processing device configured to:
cause the rotor to rotate at a maximum angular acceleration that is associated with the minimum distance; and
cause the optical source to transmit an optical beam towards the optical element to cause the optical element to scatter the optical beam into free-space.
